(19) United States
(12) Patent Application Publication
(10) Pub. No.: US 2005/0031915 A1
(43) Pub. Date: Feb. 10, 2005

(54) Method for controlling fuel supply to a fuel cell system

(75) Inventor: Rainer Autenrieth, Grossbottwar (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/734,590

(22) Filed: Dec. 15, 2003

(30) Foreign Application Priority Data
Dec. 14, 2002 (DE) 102 58 496.6

(51) Int. Cl. H01M 8/04

(52) U.S. Cl. 429/13; 429/22; 429/23

(57) ABSTRACT

In a method for controlling fuel supply to a fuel cell system having at least one fuel cell, the power withdrawal from the fuel cell is performed via a timed switching-on and switching-off of an electric connection between the fuel cell and a consuming device, as a function of the fuel present in the fuel cell. The quantity of fuel is controlled as a function of a pause to switch-on ratio of the timed connection of the fuel cell with the consuming device in such a manner that, based on an actual value of the pause to switch-on ratio, a predefined desired value of the pause to switch-on ratio is set.

### BACKGROUND AND SUMMARY OF THE INVENTION

This application claims the priority of German patent document 102 58 496.6, filed Dec. 14, 2002, the disclosure of which is expressly incorporated by reference herein.

The invention relates to a method of controlling the fuel supply to a fuel cell system.

In a fuel cell system of the above-mentioned type described in German Patent Document DE 100 56 429 A1, electric power is withdrawn from the fuel cell in a timed manner. By virtue of such timing, a reaction occurs to the presence or absence of fuel in the fuel cell (particularly in its anode region), with respect to the line power demanded from the fuel cell. For example, the pressure in the area of the fuel cell (or in the anode region of the fuel cell) can be utilized as a parameter for the fuel offered in the fuel cell.

German Patent Document DE 197 32 117 A1 discloses a power supply system which comprises a stack of fuel cells and a battery. The required gas quantities are fed to the fuel cell by way of an electronic automatic control system, which evaluates data from numerous sensors or devices, to determine the required gas quantities. Only a few such sensors need be mentioned here as examples, such as a detection device for the residual charge of the battery, a fuel quantity supply detection device, a load quantity detection device, a charge condition estimating device and the like.

The need for a plurality of sensors can result in high expenditures and requires a corresponding amount of space. In addition to the complexity of the control/automatic control or estimation due to the large quantity of data, the detection of each individual value may contains errors. Such errors add up within the facility, which therefore becomes very susceptible to disturbances. Some of the sensors, such as the fuel quantity supply detection device, also have a correspondingly complex and high-expenditure construction and/or method of operation and are therefore also quite expensive. In addition, sensors of this type tend to malfunction more than simple sensors. They therefore increase the susceptibility to interferences and the control inaccuracy of the overall system.

In addition, due to the plurality of sensors, a high expenditure computation is required to determine the actual demand for fuel from the measured values. In addition to the disadvantage that such computation requires capacity and computing performance in an automatic electronic control system, there is also the risk that the computation may be inexact. Furthermore, cases may disadvantageously occur which are not covered by the computation process.

It is therefore an object of the above-mentioned invention to provide a method for controlling the fuel supply to a fuel cell system that permits robust and reliable control of the quantity of supplied fuel, with minimal expenditures with respect to the complexity and number of required sensors.

This and other objects and advantages are achieved by the method according to the invention in which, for controlling fuel supply to a fuel cell system having at least one fuel cell, the power withdrawal from the fuel cell is performed via a timed switching-on and switching-off of an electric connection between the fuel cell and a consuming device, as a function of the fuel present in the fuel cell. The quantity of fuel is controlled as a function of a “pause to switch-on” ratio of the timed connection between the fuel cell and the consuming device in such a manner that, based on an actual value of the pause to switch-on ratio, a predefined desired value of the pause to switch-on ratio is set.

In principle, it is always attempted to operate the fuel system at a predefined pause to switch-on ratio; for example, a value of 5%/95%. If the power demand on the fuel cell increases, a fuel deficit will occur which, as described in German Patent Document DE 100 56 429 A1, results in a rise of the pause to switch-on ratio (for example, to 7%/93%). This rise is now used as a “reason” to increase of amount of supplied fuel; specifically the quantity is controlled so that the actual value of the pause to switch-on ratio again approaches the desired value. When the power demand decreases, control takes place analogously, but in the reciprocal direction. Thus a lowering of the pause to switch-on ratio (for example, to 3%/97%), results in a lowering of the fuel quantity, until the predefined pause to switch-on ratio has been reached again.

The pause to switch-on ratio is thus a quantity which is necessarily obtained in fuel cell systems of the above-mentioned type because it represents the final power control. According to the invention, this quantity can be used to vary the amount of fuel. For this purpose, the method according to the invention uses in a particularly advantageous manner this existing quantity which, in addition, can be determined in a very simple and reliable manner, in order to influence the amount of fuel. In particular, this eliminates high-expenditure computation methods of fuel quantities from numerous sensor data, etc., which, as a result of their principle, always incorporate the risk of a malfunction.

In addition to saving sensors, computing expenditures and computing capacity, the method according to the invention also makes it possible to take into account all conceivable conditions during the loading of the fuel cell, which could hardly be achieved by the method according to the state of the art, or could be achieved only at considerable expenditures. In particular, this means that the cost of the control mechanism can be reduced, because the pause to switch-on ratio can be obtained directly from the characteristics of the fuel cell itself.

According to a particularly advantageous further development of the method according to the invention, the quantity of supplied fuel is selected such that the quantity of fuel offered to the fuel cell (or of hydrogen-containing gas generated from the fuel) is always smaller than the quantity of fuel (or hydrogen containing gas generated from the fuel) which can be converted by the fuel cell.

Because, in this embodiment of the method, less fuel is offered than can be converted by the fuel cell, the creation of a fuel excess, which frequently occurs in the cases of systems according to the state of the art, can be avoided. It thereby becomes possible to eliminate so-called purging operations during which excess fuel is blown out of the fuel cell. The energy losses always connected with such a blowing-off of fuel, which finally cause a deterioration of the efficiency of the fuel cell system, are therefore avoided.

The method according to the invention can be used with essentially any type of fuel cell system. It is not important in this case whether the fuel cell system is operated as a stationary or mobile fuel cell system or whether it is operated directly by means of the fuel or by means of a hydrogen-containing gas generated from the fuel in a gas generating device. However, it is particularly advantageous to use such a system in a mobile fuel cell system with a gas generating system, particularly in a motor vehicle.

Systems of this type, which are used in motor vehicles or other types of watercraft, landcraft or aircraft, can be used for the on-board supply of such a vehicle. They are then generally called auxiliary power units or APU's. In these systems (but also in fuel cell systems which are designed for the drive of the mobile system), the method according to the invention can be used particularly advantageously. A special advantage of such systems in mobile devices stems from the fact that frequently highly dynamic demands are made on the power to be provided by the fuel cell system, which normally consists of a stack of several fuel cells (a so-called fuel cell stack). The method according to the invention makes it possible to react rapidly to such dynamic power demands on the fuel cell in a particularly advantageous manner, by means of a simple efficient and secure control of the quantity of fuel to be supplied.

Other objects, advantages and novel features of the present invention will become apparent from the following detailed description of the invention when considered in conjunction with the accompanying drawings.

### BRIEF DESCRIPTION OF THE DRAWINGS

FIG. 1 is a conceptual block diagram of a fuel cell system using the method according to the invention;

FIG. 2 is a characteristic current—voltage curve of a fuel cell and of the consuming device loading the fuel cell; and

FIG. 3 is an example of a time-related course of the quantities relevant to the method according to the invention.

### DETAILED DESCRIPTION OF THE DRAWINGS

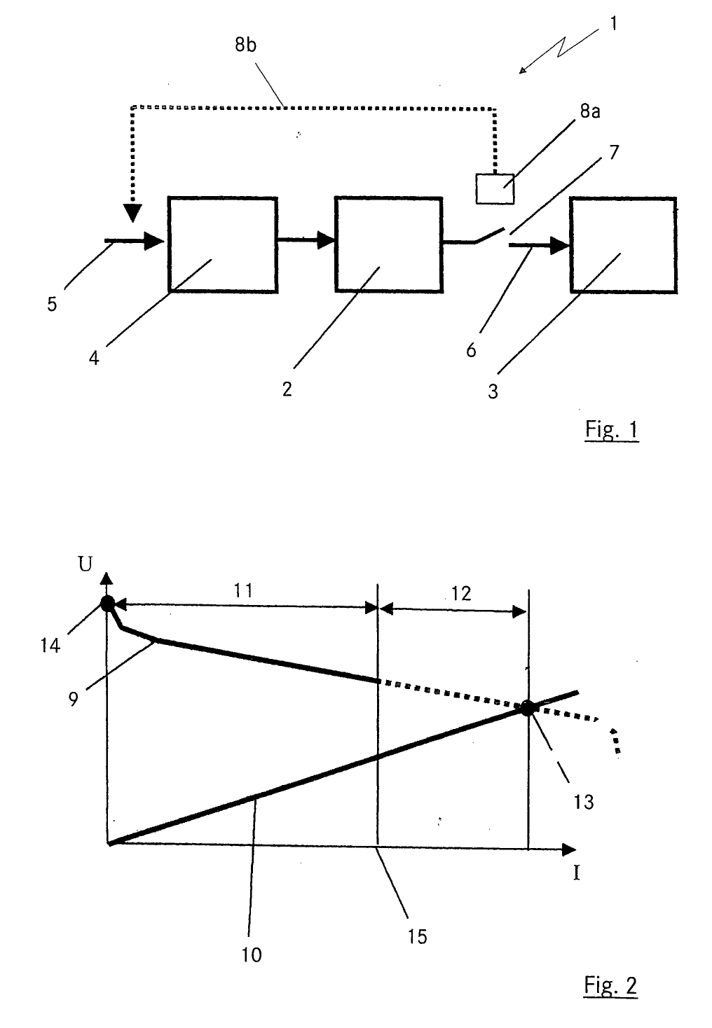

FIG. 1 is a basic diagram of a fuel cell system 1. In addition to a fuel cell 2 (for example, a fuel cell stack with membrane electrolytes (PEM)), and an electric load network in the form of a consuming device 3, the fuel cell system 1 includes a gas generating system 4. In the gas generating system 4, a hydrogen-rich gas is generated (in a known manner) from applied substances having carbon and hydrogen (for example, alcohols and hydrogen carbons, such as gasoline, diesel, or the like), by the reforming and subsequent cleaning of the reformate, or otherwise. It should be noted, however, that this construction of the fuel cell system 1 with the gas generating system 4 is not absolutely necessary for the mode of operation of the method described herein. Instead of the gas generating system 4, an intermediate storage reservoir for the fuel (for example hydrogen) supplied to the fuel cell 2 (or in the case of a direct methanol fuel cell, a water methanol mixture) can also be arranged.

Regardless of whether fuel 5 is supplied to gas generating system 4 (as shown in FIG. 1), to the fuel cell 2 or to an intermediate storage reservoir, the supplied quantity of fuel must be controlled such that the fuel cell 2 can be supplied with sufficient fuel or hydrogen generated therefrom in the gas generating system 4.

As noted previously, the electric power reaching the consuming device 3 from the fuel cell 2 is timed by a switching-on and switching-off of an electric connection 6 between the fuel cell 2 and the consuming device 3 by means of a switch 7. The basic operating principle of the switch 7 as well as the power control connected with it are known, for example, from the initially mentioned German Patent Document DE 100 56 429 A1. The switch 7 may be an electronic switch, such as a MOSFET or the like. The control of the power flowing between the fuel cell 2 and the electric consuming device 3 is implemented in a known manner, as a function of the fuel actually present or available at the point in time of the power demand in each case directly at the fuel cell 2 or its anode region. This can be based on the fuel cell 2 alone, or on the fuel cell 2 in combination with an energy storage device, such as a battery, a supercap or combinations thereof.

A method of controlling the fuel supply 5 in the fuel cell system of FIG. 1, is explained in detail hereinafter. This method is symbolically indicated in FIG. 1 by a box 8a symbolizing the pause to switch-on ratio (P/E) of the switch 7 as well as by a feedback 8b to the fuel supply 5 which is illustrated by a broken line and is based on this pause to switch-on ratio P/E.

In a current—voltage (I-U) diagram, FIG. 2 shows a characteristic curve 9 of the fuel cell 2 together with a characteristic curve 10 of the electric consuming device 3. The characteristic curve 9 of the fuel cell 2 is divided into two different ranges, the first section marked 11 showing the characteristic curve of the fuel cell 2 in the case of a stationarily limited fuel supply. The broken-line range of the characteristic curve 9 (in section 12) would represent the basically occurring characteristic curve 9 at a higher fuel supply. In this range of the characteristic curve 9, the operating point 13 occurs as an intersecting point between characteristic curves 9 and 10. The broken-line range of the characteristic curve 9 in section 12 between the operating point 13 and section 11 of the characteristic curve 9 of the fuel cell 2 symbolizes the operating condition in which the fuel cell is disconnected from the consuming device 3 by an opening of the switch 7, thus implementing the condition which is called the pause (P) during the timed switching of the connection 6 between the fuel cell 2 and the consuming device 3. In contrast, the above-described section 11 describes the closed condition of the switch 7, implementing the switch-on condition (E) of the fuel cell 2, from the view of the electric consuming device 3.

The intersecting point of the characteristic curve 9 with the voltage axis U supplies the point 14 which symbolizes the switched-off condition of the fuel cell 2. In operation, the fuel cell 2 is switched back and forth between this point 14 (switched off), and the operating point 13 which will or would occur after the switching-on of the fuel cell 2. With this manner of operation, a time average current is provided and can be consumed by the consuming device 3 which corresponds approximately to the range marked 15 on the current axis 1 in the current voltage diagram. Section 12, which is situated between this range 15 and the operating point 13, in practice indicates the lacking current and thus finally also the amount of lacking fuel in the fuel cell system 1. This lacking current in relation to the electric current generated on average is in this case also reflected in the pause ratio or pause to switch-on ratio (P/E) of the switch 7 or of the fuel cell 2. It can thus be ideally used for controlling the fuel supply 5.

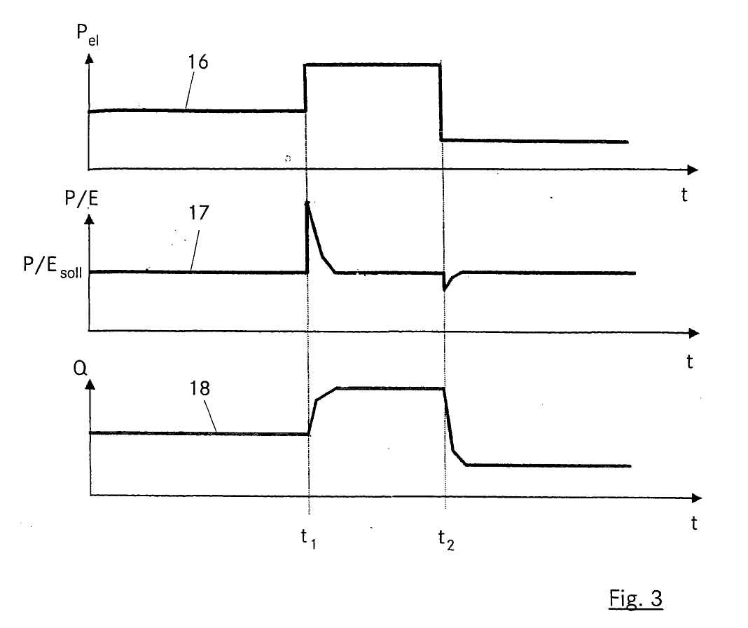

This control of the fuel supply 5, which was symbolically illustrated in FIG. 1, will be explained in detail in the following by means of the examples represented in FIG. 3, in which various quantities relevant to the method are indicated over the time t. The first (uppermost) waveform illustrates the time course 16 of a power demand or of a power request Pₑ₁ defined by a consuming device 3. The middle waveform (P/E), with an analogously extending time axis t, illustrates the time course 17 of the pause to switch-on ratio (P/E) of the connection 6 between the fuel cell 2 and the consuming device 3, while the third waveform shows an analogous time course 18 of the quantity Q of fuel metered in the area of the fuel supply 5.

An increase of the actual power request Pₑ₁ occurs at point in time t₁, resulting in a sudden demand for additional fuel, such as hydrogen, in the fuel cell 2. Since, however, at this point in time, the same amount of hydrogen continues to be produced as before, a reaction to the increased power demand because of the lack of hydrogen can only take place in that the fuel cell is switched on and off more frequently and the pause to switch-on ratio (P/E) of the fuel cell 2 is therefore increased. The related processes are described in detail in the above-mentioned German Patent Document DE 100 56 429 A1.

This change of the pause to switch-on ratio (P/E), which thus necessarily occurs in a fuel cell system 1 of the above-mentioned type, due to the deficit of fuel or hydrogen in the fuel cell 2 at the point in time t₁ of the increased power request Pₑ₁, is now used as the basis for the method of controlling the fuel supply 5 described here. That is, the quantity Q of fuel supply 5 is controlled as a function of the pause to switch-on ratio (P/E) of the timed connection 6 of the fuel cell 2 and the consuming device 3, such that, based on the actual value (P/E)_{actual} of the pause to switch-on ratio (P/E), illustrated corresponding to the respective points in time by the course 17, a predefined desired value ((P/E)_{desired}) of the pause to switch-on ratio (P/E) is set once again.

In this case, if possible, the fuel cell system 1 is always operated with a predefined pause to switch-on ratio P/E which simultaneously corresponds to the desired value (P/E)_{desired} of the pause to switch-on ratio P/E (for example, P/E=5%/95%). If the power request Pₑ₁ to the fuel cell 2 changes at time t₁, as shown in FIG. 3, a fuel deficit occurs which, as described above, in the case of a fuel cell system 1 of the above-mentioned type, necessarily leads to an increase of the pause to switch-on ratio P/E (for example to 10%/90%). The pause to switch-on ratio P/E now has the actual values (P/E)_{actual} illustrated in the course 17, which, at the point in time t₁ and at the immediately following time periods, deviate from the predefined desired value (P/E)_{desired}.

When the actual values (P/E)_{actual} deviate from the desired value (P/E)_{desired} of the pause to switch-on ratio P/E at time t₁, the system responds according to the method described here, by increasing the quantity Q of metered fuel supply 5, as can be recognized in course 18 of the quantity Q over the time t. With such an increase in the provided quantity Q of fuel, the quantity of fuel or hydrogen available in the fuel cell 2 also increases, after a brief time delay. Corresponding to the above-explained relationships, this causes a pause to switch-on ratio P/E to decrease, so that the actual value (P/E)_{actual} of the pause to switch-on ratio approaches the desired value (P/E)_{desired}. The adjustment (increase) of the quantity Q of the fuel supply 5 is thus controlled in such a manner that the actual value (P/E)_{actual} of the pause to switch-on ratio P/E is adjusted again to the desired value (P/E)_{desired}, as rapidly as possible and without overshooting.

When the power request Pₑ₁ is reduced, control takes place analogously but in the reciprocal direction, thus connected with a lowering of the pause to switch-on ratio P/E, for example, to 4%/96%, and a lowering of the fuel quantity Q, until the predefined pause to switch-on ratio (P/E)_{desired} has been reached again. A corresponding course is illustrated in FIG. 3 as an example starting at the point in time t₂. Customary values for the actual values (P/E)_{actual} in this case depend on the fuel cell system 1 itself, particularly on the possible presence of an energy storage device connected in parallel to the fuel cell 2. However, in practice, the actual values (P/E)_{actual} will rarely exceed of approximately 30%/70%.

For controlling the quantity Q of fuel in the fuel supply 5 to the desired value (P/E)_{desired} of the pause to switch-on ratio P/E, in a particularly advantageous manner, a normal and customary PID control can be implemented. However, when developing the invention, the inventor found in numerous experiments that a comparatively large surge of the system may occur, and that the PID control requires a comparatively large storage and computing capacity.

According to a further development, therefore, the change of the quantity Q of supplied fuel can take place such that a new fuel quantity Q_{new} is determined from the product of the previous fuel quantity Q_{old}, a correction factor and possibly a damping factor F_{D}. In this case, the damping factor F_{D} is predefined between 0.1 and 1 in a manner known per se. In the case of a small actual value (P/E)_{actual} (for example, smaller than 10%/90%), of the pause to switch-on ratio P/E, the damping factor F_{D} is clearly defined to be smaller than in the case of a larger actual value (P/E)_{actual} of the pause to switch-on ratio P/E. The damping factor F_{D} therefore changes analogously to the size of the pause to switch-on ratio P/E—the damping itself inversely thereto, so that the damping is always sufficient, but not excessive in the case of large required changes.

The correction factor is determined as the sum of one plus the difference between the desired value (P/E)_{desired} and the actual value (P/E)_{actual} of the pause to switch-on ratio P/E. The new quantity of fuel is therefore ideally obtained according to the statement Q_{new}=Q_{old}*F_{D}*(1+((P/E)_{desired}−(P/E)_{actual}).

By means of such a simple computation of the new fuel quantity Q_{new}, a very efficient control can be implemented which, as demonstrated in experiments, operates virtually without any shooting-up.

In addition, care should be taken to assure that the quantity Q of supplied fuel is controlled such that, in each case, the pause to switch-on ratio P/E is as small as possible. In particular, the pause to switch-on ratio P/E should be within the range of the control accuracy of the gas generating system so that the current (which in the diagram according to FIG. 2, should be assigned to the area marked 15, at least with respect to the time average) is in all events lower than or equal to the current at operating point 13. As a result, it is possible to prevent the production of excess hydrogen, which the fuel cell 2 cannot convert. As in the case of a hydrogen excess occurring during an (over) shooting of the control, such an excess of hydrogen would have to be removed from the fuel cell system 1 by blowing it off and (as required) burning or the like. However, such an operation (generally called purging) would always be connected with a loss of fuel, and thus also with a loss of energy, and therefore with reduced efficiency.

A control which reliably observes the above-mentioned aspects, therefore ensures that, although all parts of the system may carry the risk of control inaccuracies, it is always ensured that the generated quantity of fuel is smaller than, or at most equal to, the quantity of fuel which can be converted in the fuel cell 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method of controlling the fuel supply to a fuel cell system comprising at least one fuel cell, in which power withdrawn from the fuel cell and provided to a consuming device is switched on and off in a timed manner via an electric connection between the fuel cell and the consuming device, as a function of the fuel existing in the fuel cell, wherein:
a quantity of fuel supplied to the fuel cell system is controlled as a function of a pause to switch-on ratio of said electric connection, such that, based on an actual value of the pause to switch-on ratio, a predefined desired value of the pause to switch-on ratio is restored.

2. The method according to claim 1, wherein the predefined pause to switch-on ratio is selected to be below approximately P/E=10%/90%.

3. The method according to claim 1, wherein the quantity of fuel is supplied to a gas generating system in which a hydrogen-containing gas is generated for operation of the fuel cell.

4. The method according to claim 3, wherein the predefined pause to switch-on ratio is selected to be within control accuracy of the gas generating system.

5. The method according to claim 1, wherein the quantity of supplied fuel is selected such that the quantity of fuel offered to the fuel cell or of hydrogen-containing gas generated from the fuel is always smaller than a quantity of fuel or of hydrogen—containing gas generated from the fuel, which can be converted by the fuel cell.

6. The method according to claim 1, wherein a PID control is used for controlling the quantity of supplied fuel.

7. The method according to claim 1, wherein the control of the quantity of supplied fuel takes place such that a new fuel quantity is determined at least from the product of the previous fuel quantity and a correction factor, the correction factor including at least the desired values and actual values of the pause to switch-on ratio (P/E).

8. The method according to claim 7, wherein the correction factor is the sum of one plus the difference between the desired value and the actual value of the pause to switch-on ratio.

9. The method according to claim 7, wherein:
the product also includes a damping factor which is between 0.1 and 1; and
in the case of a relatively smaller actual value of the pause to switch-on ratio, the damping factor is smaller than in the case of a relatively larger actual value of the pause to switch-on ratio.

10. The method according to claim 1, wherein the fuel cell system is a mobile fuel cell system.

11. A method of controlling operation of a fuel cell in a fuel cell system, comprising:
regulating a power output of said fuel cell by opening and closing a connection between an output of said fuel cell and an electrical load; and
controlling a flow of fuel to said fuel cell system as a function of an open/close ratio of said connection.

12. The method according to claim 11, wherein said controlling step comprises performing closed loop control of said flow of fuel, using a negative feedback process, based on a difference between an actual value of said open/close ratio and a desired value of said open/close ratio.

13. The method according to claim 12, wherein the control of the quantity of supplied fuel takes place such that a new fuel quantity is determined at least from the product of the previous fuel quantity and a correction factor, the correction factor including at least the desired values and actual values of the pause to switch-on ratio (P/E).

14. The method according to claim 13, wherein the correction factor is the sum of one plus the difference between the desired value and the actual value of the pause to switch-on ratio.
